(19) United States
(12) Patent Application Publication
(10) Pub. No.: US 2026/0353209 A1
(43) Pub. Date: Nov. 5, 2026

(54) METHODS FOR LOW-LATENCY MOBILITY IN 6G

(71) Applicant: InterDigital Patent Holdings, Inc., Wilmington, DE (US)

(72) Inventors: Martino Freda, Laval (CA); Brian Martin, Farnham (GB); Keiichi Kubota, Setagaya-Ku (JP); Samuli Turtinen, Ii (FI); Faris Alfarhan, Montreal (CA); Paul Marinier, Brossard (CA); Tuong Hoang, Montreal (CA); Francois Periard, Montreal (CA); Pascal Adjakple, Great Neck, NY (US); Diana Pani, Montreal (CA); Ghyslain Pelletier, Montreal (CA); Benoit Pelletier, Roxboro (CA)

(73) Assignee: InterDigital Patent Holdings, Inc., Wilmington, DE (US)

(21) Appl. No.: 19/199,011

(22) Filed: May 5, 2025

(51) Int. Cl. H04W 36/00; H04W 48/20

(52) U.S. Cl. CPC H04W 36/00837; H04W 36/0058; H04W 36/008355; H04W 48/20

(57) ABSTRACT

A wireless transmit/receive unit (WTRU) comprising a processor is disclosed. The processor is configured to receive configuration information from a source cell, wherein the configuration information comprises a plurality of conditions associated with a mobility event. In response to a mobility event to a target cell being triggered, the processor is configured to determine a respective value for each condition of the plurality of conditions. The processor is configured to send one or more messages to the target cell during an access procedure, wherein the one or more messages comprise the respective value for each condition of the plurality of conditions.

### BACKGROUND

Mobility in New Radio (NR) is based on Radio Resource Control (RRC) reconfiguration. In RRC reconfiguration, a wireless transmit/receive unit (WTRU) receives an RRC message with a full configuration of all possible RRC parameters, or a delta configuration which changes only certain RRC parameters to be changed, leaving the parameters not included to be unchanged compared to the currently stored/applied configuration.

In handover, a WTRU receives an RRC configuration of the target cell in the handover command. The RRC configuration can be a full configuration or delta configuration and represents the WTRU's configuration to use in the target cell.

To reduce the latency associated with L3 mobility, NR also introduces L1/L2 mobility (LTM). In LTM, the WTRU receives a list of candidate cell configurations in advance (i.e., before the handover). The cell switch command is issued with a cell ID, and the WTRU simply uses the cell configuration it has stored for the respective cell.

### SUMMARY

An example wireless transmit/receive unit (WTRU) is disclosed that includes a processor. The processor is configured to receive configuration information from a source cell, wherein the configuration information comprises a plurality of conditions associated with a mobility event. The processor is further configured to, in response to a mobility event to a target cell being triggered, determine a respective value for each condition of the plurality of conditions. The processor is further configured to send one or more messages to the target cell during an access procedure, wherein the one or more messages comprise the respective value for each condition of the plurality of conditions.

In examples, the access procedure occurs before a radio resource control (RRC) exchange is performed between the WTRU and the target cell. In examples, the plurality of conditions comprise one or more of: (i) one or more measurements associated with at least one of the source cell or a neighboring cell during the mobility event, (ii) one or more properties of data available for transmission at the WTRU, (iii) one or more properties of transmission resources available to the WTRU, (iv) one or more properties of the target cell, (v) power consumption at the WTRU, (vi) one or more quality of service (QoS) levels associated with the WTRU, (vii) capabilities of the WTRU, (viii) an identifier associated with the configuration information, or (ix) or a cell or group of cells which provided the configuration information. In examples, the configuration information comprises a plurality of layer 1 (L1)/layer 2 (L2) configuration parameters and a plurality of configuration indices associated with the plurality of L1/L2 configuration parameters. In examples, the processor is configured to determine a configuration index and configuration parameters for the WTRU to use with the target cell based on a type of mobility or reconfiguration procedure, wherein the type of mobility or reconfiguration procedure is associated with one or more of: (i) a feature of a network architecture, (ii) an enabling of one or more of a new service, operation mode, capability, or category at the WTRU, (iii) an absence of information broadcast by the target cell, or (iv) an absence of support by the target cell of one or more of a feature, functionality, or configuration. In examples, if the type of mobility or reconfiguration procedure is a first type, the processor is configured to store a list of L1/L2 configurations in a conditional configuration as a new list of L1/L2 configurations and apply an L1/L2 configuration indicated by the configuration index. In examples, if the type of mobility or reconfiguration procedure is a second type, the processor is configured to apply an L1/L2 configuration indicated by the configuration index. In examples, the processor is configured to determine the type of mobility or reconfiguration procedure based on at least one condition of the plurality of conditions. In examples, the processor is configured to receive, from the target cell, an indication of the type of mobility or reconfiguration procedure. In examples, the processor is configured to select the target cell based on a triggered event or data received by the WTRU.

An example method performed by a wireless transmit/receive unit (WTRU) is disclosed. The method involves receiving configuration information from a source cell, wherein the configuration information comprises a plurality of conditions associated with a mobility event. The method further involves, in response to a mobility event to a target cell being triggered, determining a respective value for each condition of the plurality of conditions. The method further involves sending one or more messages to the target cell during an access procedure, wherein the one or more messages comprise the respective value for each condition of the plurality of conditions.

In examples, the access procedure occurs before a radio resource control (RRC) exchange is performed between the WTRU and the target cell. In examples, the plurality of conditions comprise one or more of: (i) one or more measurements associated with at least one of the source cell or a neighboring cell during the mobility event, (ii) one or more properties of data available for transmission at the WTRU, (iii) one or more properties of transmission resources available to the WTRU, (iv) one or more properties of the target cell, (v) power consumption at the WTRU, (vi) one or more quality of service (QoS) levels associated with the WTRU, (vii) capabilities of the WTRU, (viii) an identifier associated with the configuration information, or (ix) or a cell or group of cells which provided the configuration information. In examples, the configuration information comprises a plurality of layer 1 (L1)/layer 2 (L2) configuration parameters and a plurality of configuration indices associated with the plurality of L1/L2 configuration parameters. In examples, the method further involves determining a configuration index and configuration parameters for the WTRU to use with the target cell based on a type of mobility or reconfiguration procedure, wherein the type of mobility or reconfiguration procedure is associated with one or more of: (i) a feature of a network architecture, (ii) an enabling of one or more of a new service, operation mode, capability, or category at the WTRU, (iii) an absence of information broadcast by the target cell, or (iv) an absence of support by the target cell of one or more of a feature, functionality, or configuration. In examples, if the type of mobility or reconfiguration procedure is a first type, the method further involves storing a list of L1/L2 configurations in a conditional configuration as a new list of L1/L2 configurations and applying an L1/L2 configuration indicated by the configuration index. In examples, if the type of mobility or reconfiguration procedure is a second type, the method further involves applying an L1/L2 configuration indicated by the configuration index. In examples, the method further involves determining the type of mobility or reconfiguration procedure based on at least one condition of the plurality of conditions. In examples, the method further involves receiving, from the target cell, an indication of the type of mobility or reconfiguration procedure. In examples, the method further involves selecting the target cell based on a triggered event or data received by the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart diagram illustrating a method according to an embodiment.

### DETAILED DESCRIPTION

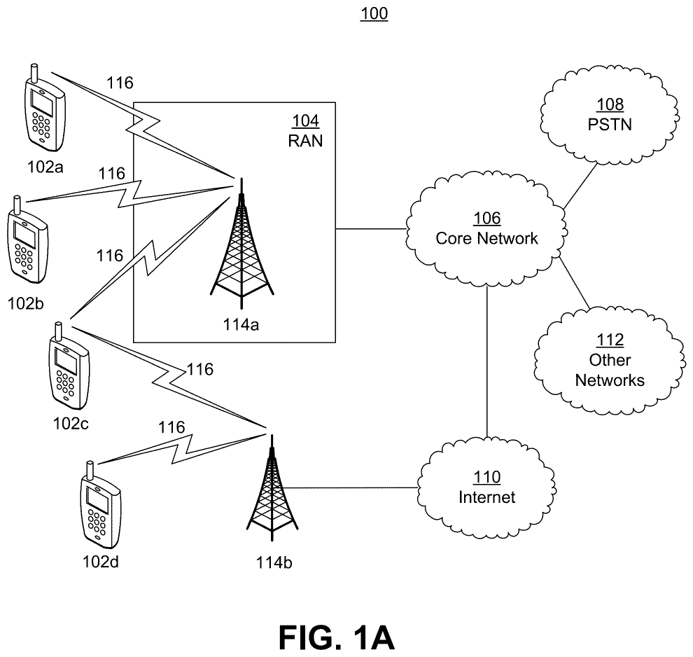

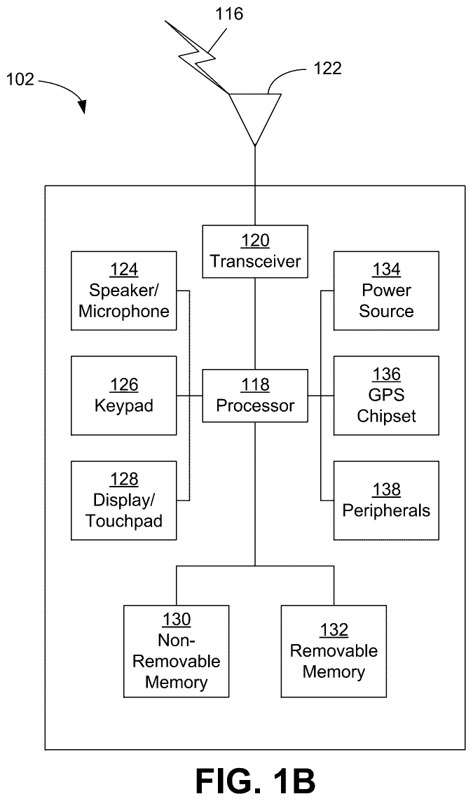

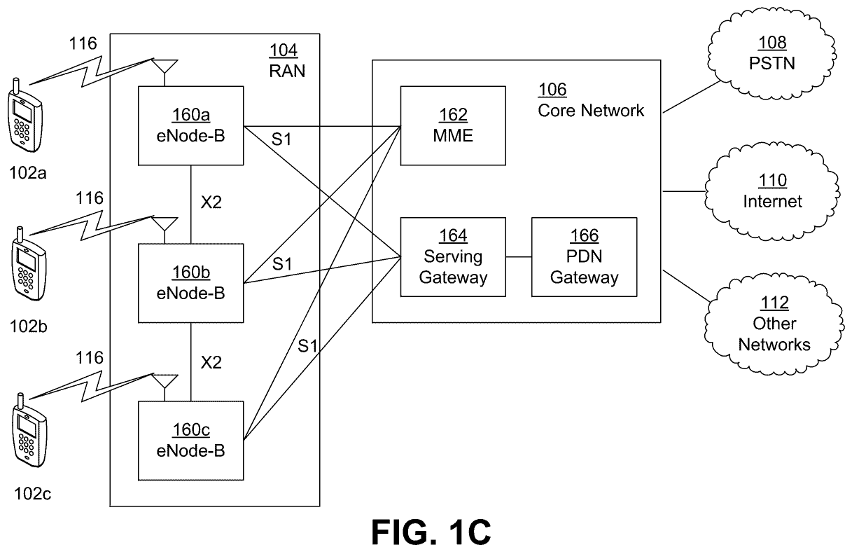

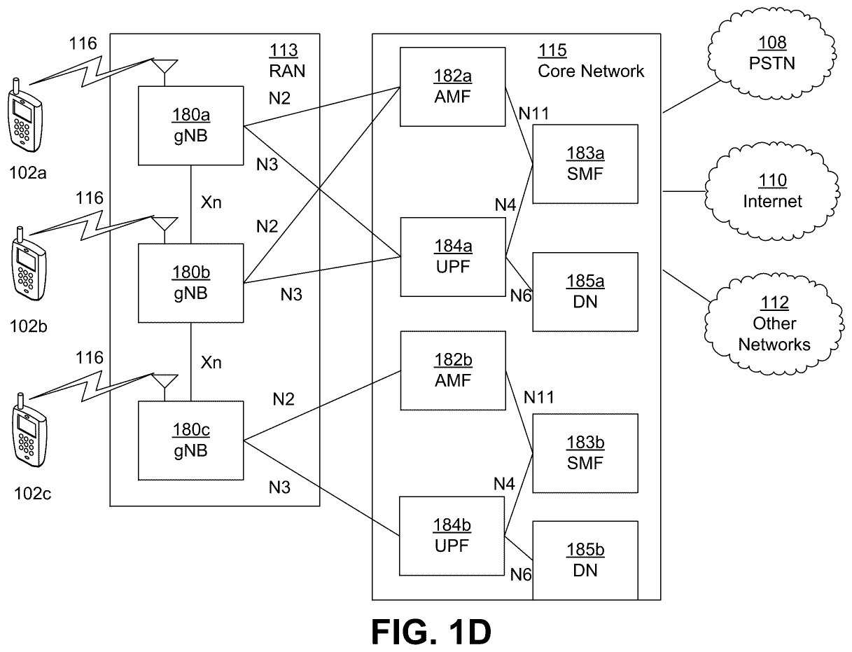

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An important consideration for 6G is network energy savings. While network energy savings has been discussed in 5G by introducing cell Discontinuous Transmit (DTX)/Discontinuous Reception (DRX), 6G may introduce more layers of network energy savings for the cell. Effectively, a cell may operate with different capabilities, configurations, etc., such as with a different time, frequency, or geographical footprint. For example, a cell may operate over a first frequency or frequency range or a second frequency or frequency range depending on the number of connected WTRUs or the congestion in the cell. Other factors may result in cells that can have different operating properties which may change as WTRUs join or leave the cell, and/or as traffic in the cell increases or decreases. Therefore, rather than operating the cell for the worst case usage scenario, a cell's operation may be “tuned” to get the proper amount of resources without consuming more energy than necessary at the network.

With this assumption in mind, mobility of WTRUs may require the configuration of the cell to be updated to address the needs of the WTRU which arrives at the cell. With traditional handover, the cell can be prepared by signaling (e.g., handover preparation) between the source and target cell. However, when the mobility is triggered by the WTRU (e.g., as a result of conditional mobility triggers), advanced preparation of the target in case of mobility conflicts with the goal of power savings at the network.

Another important 6G consideration is modular design and scalability of WTRUs. In particular, the 6G design should be able to target all types of WTRUs (including Internet of things (IOT), WTRUs with limited capabilities, etc.) using the same basic framework configuration framework. If a WTRU supports more enhanced services/capabilities, it may enable some hardware features which may need to be configured as a result. However, whether such features are enabled or not within such a WTRU may depend highly on the current state of the WTRU (e.g., the bearers configured, the QoS flows activated, the data available for transmission) and the WTRU's environment (e.g., cell measurements, interference). For this reason, and due to the variable cell operation discussed above, a WTRU's optimal configuration in a cell may vary considerably over time. The optimal configuration for a WTRU within a cell may therefore change quickly for a WTRU during the time it is prepared for, or may need to perform, mobility to a target cell.

Many of the enhancements made in 5G dealt with reduction of latency. For example, in mobility, to deal with latency associated with connected mode mobility (e.g., handover) and the resulting failures (e.g., handover failures), 5G introduced conditional handover (CHO). CHO was used to eliminate the latency associated with measurement reporting. Additional latency was reduced by introducing L1/L2 triggered mobility (LTM) where the handover could be signaled by, and measurements could be performed by, the lower layers.

Such techniques may have some shortcomings considering the foregoing 6G assumptions.

First, Optimal lower-layer configuration at a WTRU often depends on current service status, pending data at the WTRU, or cell measurements. However, L 1/L2 mobility (LTM) in 5G and conditional mobility techniques do not take these factors into account, as they are mostly reliant on measurement conditions to decide on mobility decisions. Furthermore, with conditional mobility in 5G, the WTRU can only be provided with a single RRC configuration for each cell, thus not considering aspects specific to the WTRU or the cell at a given time. To consider changes at the WTRU, the RRC configuration in the target cell would need to be updated each time.

Second, 5G mobility does not take into account the possibility of some cells, including the current cell, being in power savings mode (e.g., Network Energy Saving (NES)) when the WTRU requires a mobility procedure. How to ensure timely mobility is performed in this situation. It may be beneficial to serve a WTRU in a different cell (e.g., on a different frequency) due to the power savings properties of that cell.

Furthermore, if configuration of L1/L2 is performed by lower layer signaling and handled by the Distributed Unit (DU) (e.g., using Medium Access Control (MAC) Control Element (CE)), a mechanism is required for mobility between DUs controlled by different Centralized Units (CUs) which would minimize the DU/CU interaction during the reconfiguration.

Therefore, methods for performing low-latency, as well as low reconfiguration overhead, mobility at a WTRU that considers WTRU-specific conditions at the WTRU (e.g., data/service requirements) as well as conditions associated with the target cell status (e.g., cell level congestion, cell power savings) are desirable.

In embodiments, a WTRU may trigger a mobility procedure based on data, capability, and/or measurement condition at the WTRU, and determine the updated configuration and the type of procedure to perform to change configuration based on the condition and the ability of the target cell to support the condition. The WTRU may be configured (e.g., by RRC) with a list of configurations (e.g., L1/L2) and associated configuration index. This may comprise Logical Channel (LCH) configuration, Physical Downlink Control Channel (PDCCH) monitoring configuration, reference signals, and/or the like. The WTRU may be configured (e.g., by RRC) with a list of conditions determined at the WTRU at the time of a mobility trigger. For example, the WTRU may be configured with (i) data arrival/status at one or more bearers; (ii) measurements of the cell/carrier during the event trigger; (iii) activity level of the selected target cell; and/or (iv) activity level or service level at the WTRU and/or support of such by the target cell.

Upon triggering a mobility (e.g., upon network triggered handover command, conditional mobility triggered at the WTRU, etc.), the WTRU may determine the associated condition at the time of the triggered mobility. The WTRU may determine, from the list of conditions, one or more information elements to be provided to the network during the mobility event (e.g., condition value, measurement value, etc.). The WTRU may select a cell supporting the triggered event or data status. For example, the WTRU may select a cell based on contents of the SIB of the cell. The SIB of each cell may broadcast the supported event types. Additionally, or alternatively, the WTRU may select a cell based on cell energy configuration (e.g., NES) currently active at the cell and the ability of the cell energy configuration to satisfy the event. The WTRU may initiate an access procedure (e.g., Random Access Channel (RACH)) to the selected cell by providing the determined information element(s). The WTRU may determine (e.g., based on the condition) and/or receive, from the target cell (e.g., based on the response in the access procedure) an indication of the type of mobility/reconfiguration to perform, along with a configuration index. The WTRU may determine the WTRU's configuration in the target cell based on the determined or received mobility or reconfiguration procedure. For example, the WTRU may store the list of L1/L2 configurations in the conditional configuration as the new list of L1/L2 configurations and apply the L1/L2 configuration indicated by the received configuration index, if a first response type is received (e.g., new configuration list). The WTRU may apply the L1/L2 configuration indicated by the received configuration index if a second response type is received (e.g., maintain configuration list).

Herein, “L1/L2 configuration” or “configuration” may refer to any parameter associated with physical layer (PHY), MAC, and/or other L1/L2 which can be modified by a configuration function or procedure. Specifically, this may refer to L1/PHY configuration: PDCCH configuration, Physical Uplink Control Channel (PUCCH) configuration, Control Resource Set. (CORESET) configuration, Hybrid Automatic Repeat Request (HARQ) codebook configuration, reference signal configuration, Sounding Reference Signal (SRS) configuration, Synchronization Signal Block (SSB) configuration, Channel State Information Reference Signal (CSI-RS) configuration, power control configuration, Discontinuous Reception (DRX) timers and counters, wake-up signal (WUS) configuration, configuration for operation with NES cells, Forward Error Correction (FEC) error control parameters, and/or the like. Additionally, or alternatively, this may refer to L2 Access Configuration: Physical Random Access Channel (PRACH) resources, DRX timers and counters, WUS configuration, SSB configuration, Scheduling Request (SR) configuration, Buffer Status Report (BSR) configuration, Dynamic Scheduling Request (DSR) configuration, congestion information reporting (e.g. percentage of packet to mark) to assist base station with uplink L4S Explicit Congestion Notification (ECN) packet marking, integrity and security protection algorithms. Additionally, or alternatively, this may refer to L2/Quality of service (QoS) configuration: LCH configuration, QoS flow configuration, per-packet QoS treatment configuration, Link Control Protocol (LCP) configuration, MAC CE priorities, QoS flow/bearer to LCH mapping restrictions, packet level erasure error control parameters through Automatic Repeat Request (ARQ), packet level erasure error control parameters through FEC, per-packet QoS treatment configuration including configuration parameters for computing efficiency, device/network energy consumption efficiency, artificial intelligence/machine learning (AI/ML) efficiency (e.g. data efficiency, time efficiency, inference efficiency, etc.), and/or the like.

A WTRU may determine an event or condition related to a mobility action. For example, a WTRU may be configured with an event or a condition for triggering a mobility action. A mobility action may be one or more of: (i) initiating a conditional handover to a target cell associated with an event, via configuration; (ii) initiating a cell selection procedure (iii) and/or determining an information element to be provided to the target of a mobility procedure.

With regards to initiating a conditional handover to a target cell associated with an event, via configuration, an event may be configured at the WTRU based on conditions. The WTRU may initiate a conditional mobility (e.g. CHO, Conditional L1/L2 Triggered Mobility (C-LTM)) to a target cell upon the condition being met.

With regards to initiating a cell selection procedure, a WTRU may initiate cell selection following the event or condition, whereby such cell selection may identify the target or attempted target of the mobility. Cell selection may be performed using conditions or procedures defined herein.

With regards to determining an information element to be provided to the target of a mobility procedure, a WTRU may initiate a mobility procedure (e.g., handover, CHO, LTM, C-LTM, etc.) to a target cell and may provide information about the event or condition which triggered the mobility procedure. Determination of the information to send to the cell may be based on evaluation of a condition. The format of such information and how it is provided is described further herein.

For example, a mobility action (e.g., CHO, C-LTM) may be triggered upon the occurrence of an event. The mobility action may comprise an access procedure performed to a target cell.

In another example, the WTRU may trigger an access to a target cell upon the occurrence of an event, and may also provide information of the event itself as part of the access. Methods for providing such information are described herein.

In another example, the trigger for the access may occur upon the occurrence of an event. A WTRU may further evaluate a separate condition at the time of the event. For example, the WTRU may determine, either at the time of the event or prior to such, the status of a condition, or an information element determined by the evaluation of a condition. The WTRU may send the status of such condition to the target cell at the time of the access to the target cell. Additionally, or alternatively, the WTRU may send such information to a potential target cell prior to an access.

Conditions for any of the above may be in the form of one or more of the following: (i) cell measurements; (ii) properties of data or control available for transmission at the WTRU; (iii) properties of transmission resources available to the WTRU; (iv) properties of the source cell, and/or the cell(s) that triggered the event or condition and/or the cell(s) selected by the WTRU for the mobility, (v) power or energy consumption at the WTRU, (vi) condition at the WTRU associated with QoS (e.g., required QoS and/or observed QoS/Quality of Experience (QoE)), (vii) condition at the WTRU associated with its current processing capabilities, device category, device class, and the like, and/or (viii) conditions at the WTRU related to the current L1/L2 configuration.

One or more conditions may be in the form of cell measurements. The WTRU may use absolute cell measurements (e.g., current or neighbor cell above/below a threshold) or relative cell measurements (one cell compared to another cell) to determine the condition. This may comprise traditional Ax, Bx event evaluations, such as the source cell falls below a threshold, a neighbor cell is above a threshold while the source cell falls below a threshold, etc.

The condition may be a function of the type of cell measurements available. The condition may itself be the type of measurement available at the WTRU (e.g., what signal has been measured, what signal can be measured, what signal is available for measurement, etc.). The WTRU may determine whether it can measure a first type of measurement or a second type of measurement (e.g., low power signal vs main radio signal, CSI-RS vs SSB reference signal, etc.). The WTRU may determine whether it can or is configured to report a first type of measurement or a second type of measurement (e.g., cell measurement vs beam measurement, measurement with a first averaging window vs measurement with a second averaging window). The WTRU may determine whether it can report measurements with a first protocol layer reporting or a second protocol layer reporting (e.g., MAC CE vs RRC). The type of measurement may be the measurement of a first reference signal vs a second reference signal. The type of measurement may be based on whether the WTRU performs the measurement with a first radio (e.g., low power radio) versus a second radio (e.g., main radio).

The WTRU may determine which condition or how to evaluate the condition (e.g., the threshold to use) based on whether a first type of measurement or second type of measurement is available at the WTRU. If the WTRU is configured to perform measurements on a first signal, the WTRU may determine whether the measured signal is above a first threshold. Otherwise, if configured to perform measurements on a second signal, the WTRU may determine whether the measured signa is above a second threshold.

One or more conditions may be in the form of properties of data or control available for transmission at the WTRU. The WTRU may determine the condition as a function of the amount of data buffered at the WTRU, possibly associated with a specific QoS flow, bearer, or data type. For example, a condition may be satisfied if the amount of data buffered at the WTRU, possibly associated with a bearer/QoS flow, or of a specific priority, is above or below a threshold.

The WTRU may determine the condition as a function of whether a specific type of data, or a specific element of data, is available for transmission at the WTRU. A condition may be satisfied if: the WTRU has data for a specific bearer/QoS flow, or data type available for transmission; the WTRU has data for a specific service (e.g. data collection) available for transmission; the WTRU has signaling data available for transmission; and/or the WTRU has data for retransmission available.

The WTRU may determine the condition as a function of a required or observed latency or delay of data available for transmission. For example, the condition may be satisfied if the remaining latency associated with a buffered packet is above or below a threshold. For example, the condition may be satisfied if the average, maximum, and/or minimum amount of time for a packet to be transmitted is above or below a threshold.

The WTRU may determine the condition as a function of the size of the data available. For example, this may be a condition on the size of one or more buffered Packet Data Units (PDUs). For example, this may be a condition on the size of one or more control elements to be transmitted.

One or more conditions may be in the form of properties of transmission resources available to the WTRU. For example, this may be a condition associated with the allocated grants at the WTRU. For example, the WTRU may determine a condition based on whether it has a configured grant available or not. For example, the WTRU may determine a condition based on the size of the grant available at the WTRU (e.g., a specific grant is larger/smaller than a threshold, amount of grant over a period of time is larger/smaller than a threshold, etc.). For example, the WTRU may determine the condition based on the type of grant available or allocated to the WTRU (e.g., RRC configured persistent grant, dynamic grant, type 1 vs type 2, etc.). For example, this may be a condition on the ability of the grant to satisfy certain data related conditions. For example, the WTRU may determine a condition based on whether a configured grant can satisfy a latency requirement associated with data. For example, the WTRU may determine a condition based on whether a configured grant is large enough to transmit a specific data element or buffered data.

One or more conditions may be in the form of property of the source cell, and/or the cell(s) that triggered the event or condition and/or the cell(s) selected by the WTRU for the mobility. This may be a condition associated with a feature, function, event, and/or service or capability level supported by the cell. For example, the cell (e.g., the target cell) may present information associated with features supported by the cell (e.g., by the presence of information associated with that feature in MIB/SIB, e.g., by explicit indication of the feature is supported or not, etc.). The WTRU may determine the condition based on whether a cell (e.g., a target cell, a cell which triggered an event, the source cell, etc.) supports a specific feature or an ongoing feature at the WTRU. The cell may broadcast or indicate the specific events or conditions that the cell supports. For example, a WTRU may determine a condition based on the whether the cell supports the event or condition that was triggered at the WTRU. This may be a condition with the relationship (e.g., network connectivity, inter/intra DU/CU, etc.) between the target or potential target cell and the source cell which can be determined by the WTRU in a number of different ways. A potential target cell may provide (e.g., in SIB or dedicated signaling) an identifier. If the identifier is the same as the identifier in the source cell, the WTRU may determine a first relationship between the cells (e.g., intra DU). If the identifier is different, the WTRU may determine a second relationship between the cells (e.g., inter-DU, inter CU, etc.). The source cell may provide a list of target cells (e.g., cell IDs) associated with a first relationship (e.g., intra-DU). If the target cell is in the list provided by the source cell, the WTRU may assume the first relationship exists. Otherwise, it may assume a second relationship (e.g., inter-DU, or inter-CU) exists. This may be a condition associated with the power savings status of the cell. A potential target cell may indicate that it is in power savings state (e.g., in MIB/SIB) and the WTRU may derive a condition based on such information. A potential target cell may indicate a level of power savings (e.g., by indicating a configured integer that is associated with a configured level of cell power savings, a value associated with the amount of power savings (e.g., cycle/duration/periodicity of the cell DRX/DTX, cell inactivity timer, etc.), and/or the like. The WTRU may derive a condition based on such information. This may be a condition associated with the RAT supported by the cell. For example, the WTRU may determine a condition as a function of whether the target cell supports a specific RAT (e.g., 5G and/or 6G).

One or more conditions may be in the form of power or energy consumption at the WTRU. This may be a condition associated with the WTRU's power savings state (e.g., DRX configuration, whether configured with low power radio or main radio, an indication of the power consumption at the WTRU at the time of an event, etc.). The condition may be related to a desired power consumption target preconfigured and/or configured at the WTRU.

One or more conditions may be a condition at the WTRU associated with QoS, with the QoS being a required QoS and/or observed QoS/QoE. This may be a condition associated with whether a specific service with QoS level is active or configured for the WTRU. This may be a condition associated with whether a specific bearer, type of bearer, QoS flow, type of QoS flow, and/or the like is configured or active at the WTRU.

One or more conditions may be a condition at the WTRU associated with its current processing capabilities, device category, device class, and/or the like. This may be a condition associated with the WTRU's processing capabilities or device category, which may be fixed for a specific WTRU. The WTRU may determine if it is of a first category, a second category, etc. The WTRU may determine if it can process a first set of cell resources, a second set of cell resources, etc. The WTRU may determine if it can receive on a first bandwidth, a second bandwidth, etc. The WTRU may determine if it can support a first network feature or a second network feature. This may be a condition associated with the current WTRU's processing power or configuration, which may be determined by the WTRU or by the network (e.g., during RRC configuration, or during connection establishment), or configured and/or determined by the WTRU based on the existing service. The WTRU may determine if it has been configured with a first configuration (e.g., L1/L2 configuration) or a second configuration. The WTRU may determine if it has been configured to operate with a first power profile or a second power profile. The WTRU may determine if it has a first remaining power or a second remaining power.

One or more conditions may be a condition at the WTRU related to the current L1/L2 configuration. The WTRU may determine a condition based on an identity (transaction ID, configuration ID, etc.) provided with the configuration. The WTRU may provide to the network during mobility, the identity of the currently active configuration at the WTRU, whereby such identity may have been provided by the network along with the configuration. The WTRU may determine a condition based on the cell or group of cells which provided the configuration. The WTRU may determine whether the current configuration was provided by the same cell or group of cells as the source cell and/or target cell.

Any combination of the above events or conditions can be used for triggering a mobility event or as a condition evaluated or provided to the target cell.

The condition may comprise a logical AND, OR, etc., of one or a set of conditions, possibly of different types. For example, the condition may comprise a measurement condition and a WTRU buffer status condition. In another example, a condition may be that the source cell RSRP falls below a first threshold, while the buffer status at the WTRU, possibly associated with a bearer, QoS flow, etc. is above a second threshold. In another example, a condition may be that there is signaling data available for transmission at the WTRU and the amount of total data is above a threshold. Other combinations of conditions with AND/OR are not precluded.

A second condition may be evaluated when a first condition is satisfied. For example, a mobility event may be triggered based on measurements (Ax events, Bx events, etc.). When such event is triggered, the WTRU may determine a condition related to a mobility action by determining, at the time of the event trigger whether the amount of data available at the WTRU is above a threshold, whether the WTRU has data available for transmission with a specific latency requirement or remaining latency (as described herein), and/or the like.

Whether to evaluate a second condition or a third condition may depend on the outcome of a first condition. For example, a WTRU may determine whether the target cell belongs to the same cell group as the source cell. In such embodiments, the WTRU may determine a condition related to a mobility action based on the measurements of the source and target cells. If the WTRU determines that the target cell is belonging to a different cell group than the source cell, the WTRU may determine a condition related to a mobility action based on the measurements of the source and target cell and the service, function supported, and/or event supported by the target cell.

An event or condition may be reported to the network. An event or condition as described above may be reported to the network, possibly during the mobility procedure (e.g., CHO, C-LTM, etc.). The WTRU may report the event or condition explicitly, by including an identifier or information element associated with the condition.

For example, a WTRU may be configured with a list of conditions or events based on one or more of the factors described above. For example, the list of conditions may be in the form of a table where each condition or event is associated with a condition or event index. The WTRU may report the event index or condition index, for example, to the target cell during the mobility procedure. Additionally, or alternatively, the WTRU may report the event index or condition index to a potential target cell (e.g., one or more or all of the configured potential target cells) prior to the mobility procedure (e.g., to enable mobility to the target in case of an event trigger).

A WTRU may report a different information element depending on the condition satisfied. For example, a first condition type (e.g., a measurement condition), when triggered, may cause the WTRU to report a measurement value while a second condition type (e.g., a data based condition) may cause the WTRU to report a buffer status or equivalent. The WTRU may report the different information elements in different message, or in the same message containing different Information Element (IE) types.

Reporting of a condition or event may be signaled by inclusion of an information element (e.g., an index or a value) when the condition is satisfied. For example, a WTRU may include an IE associated with a specific condition when the condition is satisfied.

The WTRU may report the information (e.g., event index, condition information, etc.) explicitly to the network. For example, the information may be included: (i) in data appended to the RACH preamble transmitted to the target cell; (ii) as a control element in a message (e.g., MSG3) of the random access procedure initiated to the target cell; (iii) as a MAC CE or RRC message included in the RRC complete message transmitted to the target cell; and/or (iv) as an IE included in an RRC message (e.g., the RRC complete message, RRC resume message, etc.).

How the WTRU reports the event index or condition information may further depend on one of the conditions themselves. For example, if a relationship exists between target and source cells (e.g., as determined from conditions herein), the WTRU may report the condition information using a MAC CE. Otherwise, the WTRU may report the condition information by including an IE in the RRC complete message. For example, if a relationship exists between target and source cells (e.g., as determined from conditions herein), the WTRU may report the condition information immediately using a transmission to the target (i.e., as part of handover completion transmission without RACH). Otherwise, the WTRU may report the condition information as part of the random access procedure (e.g., data attached to the preamble transmission).

The WTRU may report the event or condition implicitly. For example, the WTRU may determine the RACH preamble (or a similar transmission preamble) based on the event/condition. For example, certain RACH preambles may be associated with indication of one or more condition. Additionally, or alternatively, the WTRU may determine the resource for reporting the condition based on such condition. For example, the WTRU may be configured with multiple resources where each resource may be used for reporting of one or more conditions. Additionally, or alternatively, the WTRU may determine a Cyclic Redundancy Check (CRC) for a transmission based on such condition. For example, the WTRU may use the condition or event index to encode the CRC or similar error correction encoding

A subset of conditions or events may be associated with implicit reporting. The WTRU may then, following selection of the implicit option for that group, indicate the event or condition within the subgroup explicitly. In some embodiments, both implicit and explicit methods may be used.

One advantage of event reporting during mobility may be to initiate operation of a cell so that it can meet the service level requirements of the WTRU that is performing a mobility operation to the cell. For example, the cell may need to reconfigure itself as a result of the mobility by the WTRU.

A WTRU may determine based on the bearers and/or QoS flows active at the WTRU and/or the amount of data buffered for these bearers and/or QoS flows that a specific service level or configuration should be supported by the target cell. Such service level or configuration of the target cell may comprise, or manifest itself in the cell as, a resource allocation method, a cell bandwidth, a RAT type (e.g., 5G vs 6G), a resource partitioning, a supported numerology, a channel configuration, a reference signal configuration (e.g., for CSI-RS measurements), etc. The WTRU may determine an index or identifier related to the service level or configuration by evaluating a set of associated conditions for the bearers and/or QoS flows and buffer status. For example, the WTRU may assume an associated service level (e.g., level x) if the amount of data buffered for one or more configured QoS flows or bearers associated with a specific QoS property is larger than a threshold. The WTRU may provide an indication of the service level to the cell as part of the mobility procedure if the cell does not currently support level x (e.g., the cell does not broadcast level x in the SIB/MIB as a supported level, the configured BW of the cell is smaller than a threshold associated with x, etc.), as described herein. For example, the WTRU may assume a specific cell-level functionality to be required (e.g., high-density CSI reporting) if one or more of the QoS flows configured or active at the WTRU is associated with a specific configured and/or preconfigured property or indication (e.g., low latency, bursty traffic, high reliability, etc.). The WTRU may include such indication in the signaling to the cell (e.g., during a mobility procedure) to initiate this cell-level functionality in the cell. The WTRU may include such indication when the WTRU detects it is not currently supported or activated in the cell (e.g., based on information in MIB/SIB of the cell, or by detection at the WTRU).

A WTRU may compute a metric based on the bearers and/or QoS flows having data available for transmission at the time of the handover trigger. Such metric may comprise a weighted average buffer occupancy, where certain bearers may carry a larger weight, for example. Such metric may comprise an average of the bit rate requirements of each of the QoS flows activated at a specific time. The WTRU may require a cell where cell DTX/DRX is not activated if the metric is above a configured threshold. The WTRU may transmit an indication/request to turn off cell DTX/DRX or may transmit the value of the metric during the mobility procedure if the WTRU selects a cell with cell DTX/DRX activated (based on indication of such by the cell in the SIB/MIB).

A WTRU may determine a QoS requirement (e.g., latency) of data (either buffered or potential future data). The WTRU may send an indication to the network including a flag (e.g., to request disabling cell-level DTX) and/or a value of cell-level DTX periodicity, if the QoS requirement satisfies a condition (e.g., below a threshold) whereby the condition may be associated with the current operation of a cell (e.g., the current cell DTX period).

An advantage of the embodiments disclosed herein may be fast WTRU configuration and/or reconfiguration upon mobility, especially when the mobility is triggered at the WTRU (e.g., WTRU autonomous mobility or conditional mobility). Specifically, a WTRU may be configured with rules for determining relevant information to provide to the network at mobility to enable the network to configure an L1/L2 configuration at the WTRU when it operates in the new cell. The relevant information may be related to aspects associated with the above conditions (e.g., WTRU capabilities, buffered data, QoS requirements, cell level measurements, etc.). Furthermore, the network may select one or more configured and/or preconfigured set of L1/L2 configurations or modification of such based on the information provided, so the WTRU can be property configured at the time of mobility.

The WTRU may determine an index associated with (e.g., by RRC configuration or predefinition in the standards) a set of factor and/or conditions described above. For example, a first index may be associated with a combination of a first range of target cell measurements (e.g. RSRP) and/or first level of buffer status at the WTRU possibly associated with one or more logical channels, and/or a first WTRU capability/device type, while a second index may be associated with a combination of a second range of target cell measurements (e.g., RSRP), and/or a second level of buffer status at the WTRU, possibly associated with one or more logical channels, and/or a second WTRU capability/device type, etc. The WTRU may determine the index associated with the combination of target cell measurements and/or buffer status and/or device type at the time of the mobility, and may send the index to the network as part of the mobility procedure.

The WTRU may provide, to the target cell, information about the WTRU's L1/L2 configuration in the source cell. Such information may be represented by an index associated with a L1/L2 configuration. Additionally, or alternatively, such information may be represented by multiple indices, each index associated with one or more L1/L2 configuration parameters. Additionally, or alternatively, such information may be provided by the WTRU by explicitly sending the value of one or more configuration parameters to the network.

The WTRU may provide, to the target cell, a transaction number or a configuration number provided by the network along with the configuration. Specifically, a WTRU may be provided with one or multiple L1/L2 configurations, each with a transaction or configuration number to be stored by the WTRU. The WTRU may send the configuration number to the network upon mobility to a target cell. The WTRU may send the configuration number to the network upon mobility to a target cell with additional information associated with the source cell and/or the cell which initially provided the configuration (e.g., cell ID, area ID, etc.).

The event or condition may determine the cell selected for the mobility action. For example, a WTRU may trigger WTRU-based or conditional mobility upon an event. Based on the event or a condition determined at the event (as described herein) the WTRU may determine the specific cell to select for the mobility action. Such determination may be based on a condition related to the WTRU (e.g., service supported, power consumption, data related, etc.) described herein. Additionally, or alternatively, such determination may be based on a condition related to the cell (e.g., energy savings, events supported, etc.).

A cell may broadcast (e.g., in SIB/MIB) a list of events or event indices supported by the cell. The WTRU may first determine the event or event index at the time of the mobility trigger. The WTRU may then determine whether the cell supports the event or condition and may select among the cells which support the condition

A WTRU may be configured to perform different reconfiguration mechanisms at mobility. A WTRU may perform different mobility types where each mobility type may comprise a different mechanism for reconfiguration and/or mobility procedure.

The difference in configuration and/or mobility procedure may be caused by a feature of the network architecture. For example, one mobility procedure may comprise an intra-DU mobility. Another mobility procedure may comprise an inter-DU mobility. Another procedure may comprise an inter-CU mobility, etc. For example, one mobility procedure may be associated with moving between a first and second cell which have a first relationship between the cells. A second mobility procedure may be associated with moving between a first and second cell which have a second relationship between the cells. A WTRU may determine the network architecture and/or the relationship between the cells and the corresponding mobility type based on information presented to it by the cell itself (e.g., in the SIB/MIB) or provided by the source cell or another cell.

The difference in mobility type or procedure may be caused by the need to enable a new service, a new operating mode at the WTRU, enabling a new WTRU capability, activating a new WTRU module, etc. For example, a first procedure may be used if the mobility is triggered due to coverage related issues. A second procedure may be used if the mobility is triggered due to a change in the WTRU category, capability, and/or operating mode.

The difference in the mobility type or procedure may be caused by the absence of information broadcast by the target cell that may be required for continuity of the service at the WTRU. Similarly, it may be caused by the absence of support by the cell of a feature, functionality, configuration, etc., as described herein. The WTRU may determine the absence of such support based on information presented by the cell.

A WTRU may have different behaviors associated with the different mobility types. The difference in the mobility types may comprise and/or be based on one or more of the following: (i) how the WTRU determines its configuration parameters; (ii) the signaling, transmission, and/or reception steps associated with performing the mobility; (iii) whether the WTRU applies CHO or C-LTM; (iv) whether a security parameter is changed or reset; (v) whether to suspend transmission on certain bearers or not; (vi) when and/or how the link with the source cell is released during the mobility; (vii) a different procedure for resetting of specific layers or functions at the WTRU; and/or (viii) a different procedure for releasing or invalidating a stored configuration at mobility.

The difference in mobility types may comprise how the WTRU determines its configuration parameters (e.g., L1/L2 configuration, L3 configuration, etc.). This may comprise determining which parts of a received configuration, a broadcasted configuration, or an associated configuration (e.g., indicated by an index or a reference to a set of parameters) that is applied by the WTRU, and which parts are ignored or unused and/or are unchanged at the WTRU. For example, if the WTRU determines that a first mobility type is to be performed, it may apply, from the configuration received and/or associated to the target cell, the configuration parameters related to: (i) a specific protocol layer(s) (e.g., L1 configuration, MAC configuration, etc.); (ii) a specific function in the WTRU (e.g., LCP configuration, RLM/RLF configuration, BSR reporting configuration, etc.); (iii) specific bearer/LCH or QoS flow (e.g., priority, LCP restrictions for the bearer, retransmission configuration, latency, etc.); and/or (iv) a specific WTRU type or operating type, possibly associated with or identified as being for its current WTRU type or operating type (e.g., parameters which are applicable to a specific type of WTRU, or applicable when the WTRU operates in a specific mode).

The WTRU may determine its configuration parameters by determining when the new configuration is applied at the WTRU. For example, in one mobility type, the WTRU applies the new configuration at different times which may be any of: (i) at the trigger of the mobility/handover or upon triggering an event that initiated the mobility/handover; (ii) when the WTRU receives a message/trigger from the network to apply the configuration; (iii) when the WTRU initiates data transmission or receives new data for transmission; and/or (iv) after the WTRU reports a measurement. For example, in one mobility type, the WTRU applies a new configuration immediately. In another mobility type, the WTRU applies a default configuration temporarily, or until it is reconfigured by the network after mobility is completed.

The WTRU may determine its configuration parameters by determining the “reference” or baseline configuration that is assumed when a configuration parameter is applied using a “delta” principle or a “relative” change (e.g., increase/decrease, use the next larger value, etc.). For example, different mobility types may be associated with using different stored configurations as the reference configuration. For example, a WTRU may apply a received configuration or an associated configuration using a delta configuration on the first reference configuration when a first condition associated with performing a first mobility type is met. The WTRU may apply a received configuration or an associated configuration using a delta configuration on the second reference configuration when a second condition associated with performing a second mobility type is met. For example, different mobility types may be associated with using a reference configuration versus using the current configuration as the reference configuration. For example, the WTRU may apply the configuration as a delta on its current configuration when a first condition corresponding to a first mobility type is met. The WTRU may apply the configuration as a delta configuration on a reference configuration when a second condition corresponding to a second mobility type is met.

The WTRU may determine its configuration parameters by whether the received or associated configuration is a full configuration or a delta configuration. For example, for a first mobility type, the WTRU may interpret the received or associated configuration as a full configuration, and for a second mobility type, the WTRU may interpret the received or associated configuration as a delta configuration.

The WTRU may determine its configuration parameters by the reception mechanism used by the WTRU to determine its configuration parameters for the target cell. For example, different mobility types may comprise receiving configuration parameters using different signaling, such as: different SRB, different logical channel, different protocol layer (e.g., from a MAC CE or MAC header vs from RRC message), and/or applying a different encoding mechanism.

A WTRU may perform a combination of reconfiguration mechanisms, which may further depend on conditions herein. For example, a WTRU may be provided with a conditional configuration (e.g., a CHO-type configuration) for a cell, as well as an index for configuration of the WTRU in that cell. The WTRU, based on an event or condition herein, may determine which reconfiguration mechanism to apply and for which set of parameters and/or protocol layer(s). For example, the event may determine what portion of the CHO configuration to apply, and which parameters associated with the configuration index to apply

The difference in the mobility types may comprise the signaling, transmission, and/or reception steps associated with performing the mobility. This may comprise using a different access procedure to the target cell. For example, one mobility type may comprise performing RACH to the target cell, while another mobility type may comprise the WTRU performing RACH-less access (i.e., performing an immediate data transmission).

The signaling, transmission, and/or reception steps associated with performing the mobility may comprise sending different contents or information in the message to the target cell (e.g., the first message, the message which completes the handover, etc.). For example, the different mobility types may comprise sending the WTRU ID and/or source cell ID to the target cell differently (e.g., a different ID for the cell and/or WTRU, sending the cell ID and/or WTRU ID using a different control element or different message, different encoding, etc.). For example, the different mobility types may comprise sending or not sending certain information in the message, such as the WTRU ID, the source cell ID, the area ID, and ID associated with the previous configuration, an ID associated with system information from the source cell, event or condition information (as described herein), etc.

The signaling, transmission, and/or reception steps associated with performing the mobility may comprise receiving different information for a DL message (e.g., the first DL message) from the target cell associated with the mobility procedure. For example, the different mobility types may be distinguished by the reception or not of a specific message, or type of message received such as: (i) in one mobility type, the WTRU may receive an RRC message, while in another mobility type, the WTRU may not receive an RRC message, or may receive a MAC message; (ii) in one mobility type, the WTRU may receive a new list of configurations with associated index, while in another mobility type, the WTRU may receive a configuration index; (iii) in one mobility type, the WTRU may receive an RRC reconfiguration message, while in another mobility type, the WTRU may receive a MAC reconfiguration message; and/or (iv) in one mobility type, the WTRU may receive an RRC reconfiguration, while in another mobility type, the WTRU may receive an LTM trigger message.

The difference in the mobility types may comprise whether the WTRU applies CHO or C-LTM. For example, a WTRU may be configured with both a L3 conditional mobility configuration and a L2 conditional mobility configuration. If the WTRU determines to perform a first mobility type, it applies the L3 conditional mobility configuration (e.g., CHO), while if it determines to perform a second mobility type, it applies the L2 conditional mobility configuration (e.g., C-LTM).

The difference in the mobility types may comprise whether you change or reset a security parameter. For example, a WTRU that determines to perform a first mobility type may perform a first security parameter reset or change or a first security related operation. A WTRU which determines to perform a second mobility type may perform a second security parameter reset or change or related operation or may not perform any security parameter updates.

The difference in the mobility types may be associated with whether to suspend transmission on certain bearers or not. Whether to suspend transmission on certain bearers or not may comprise determining whether or not to suspend transmission on all bearers or a subset of bearers. For example, with a first mobility type, the WTRU may suspend transmission on all bearers (e.g., all data bearers) or on a subset of bearers (e.g., all bearers configured to behave as such, all bearers having a specific condition on a parameter such as priority, etc.) while with a second mobility type, the WTRU may not suspend transmission on bearers, or may assume transmission on a different set of bearers or subset of bearers is required. Whether to suspend transmission on certain bearers or not may comprise suspending data transmission on all bearers or a subset of bearers for a different amount of time, or until the reception of a different trigger. For example, with a first mobility type, the WTRU may suspend transmission on bearers for a first time period, while for a second mobility type, the WTRU may suspend transmission on bearers for a second time period. For example, with a first mobility type, the WTRU may suspend data transmission on one or more bearers until a first trigger (e.g., reception of a message from the network, timing/occurrence of a grant, etc.) and with a second mobility type, the WTRU may suspend data transmission on one or more bearers until a second trigger (e.g., reception of a message from the network, timing/occurrence of a grant, etc.).

The difference in the mobility types may comprise different assumption for when and/or how the link with the source cell is released during the mobility. For example, with a first mobility type, the WTRU may perform Dual Active Protocol Stack (DAPS). With a second mobility type, the WTRU may not perform DAPS. For example, with a first mobility type, the WTRU may release the source cell at a different time or based on a different trigger.

The difference in the mobility types may comprise different procedures for resetting of specific layers or functions at the WTRU. For example, with a first mobility type, the WTRU may reset a first set of protocol layers or functions (e.g. reset PDCP, RLC and MAC), while for a second mobility type, the WTRU may reset a second set of protocol layers or functions (e.g., reset MAC).

The difference in the mobility types may comprise different procedures for releasing or invalidating a stored configuration at mobility. Different procedures for releasing or invalidating a stored configuration at mobility may comprise determining whether or not to release a list of configurations, an association between one or more indices and a configuration, etc. For example, in a first mobility type, the WTRU may release the set of configurations in a list, or the specific configurations which are associated with a specific index, and in a second mobility type, the WTRU may maintain the configurations in the list. For example, in a first mobility type, the WTRU may replace the configuration associated with an index with a received configuration (while releasing the original configuration associated with that index), and in a second mobility type, the WTRU may not change or release the configuration associated with an index.

Different procedures for releasing or invalidating a stored configuration at mobility may comprise releasing the configuration associated with the operation on one or more cells. For example, in a first mobility type, the WTRU may release the configuration associated with one or more cells (e.g., the source cell, a set of cells related to the source cell, a set of cells determined and related to the target cell, etc.). In a second mobility type, the WTRU may maintain the configuration.

Different procedures for releasing or invalidating a stored configuration at mobility may comprise releasing the configuration associated with operation under different modes of the WTRU, or configuration of different WTRU functions. For example, in a first mobility type, the WTRU may release the configuration associated with a specific service type, set of functions, operating mode at the WTRU, etc., while at a second mobility type, the WTRU may not release such configuration.

A WTRU may determine the mobility type, where the mobility type may comprise performing one or more of the different behaviors described above, based on one or more of the following conditions: (i) conditions related to something presented by the cell (e.g., in SIB, MIB, SSB, etc.); (ii) conditions related to the response from the network during the handover procedure; (iii) explicit network configuration and/or indication; (iv) conditions related to functional support by the cell; (v) conditions related to the event or conditions which trigger a mobility procedure, as described herein; and/or (vi) a period of time since the WTRU was provided with the configuration.

One or more conditions may be conditions related to something presented by the cell (e. g,, in SIB, MIB, SSB, etc.). For example, a WTRU may determine its mobility type based on the presence or absence and/or value of an indication or specific information broadcast by the cell (e.g., in SIB, MIB, SSB, etc.). For example, if the WTRU moves between cells both having an identifier or having the same value of the identifier, the WTRU may consider the mobility to be of a first type, while it may consider the mobility to be of a second type otherwise. For example, if the WTRU moves to a cell that has an indication or identifier present, the WTRU may consider the mobility to be of a first type, while if the cell does not have the indication or identifier present, the WTRU may consider the mobility to be of a second type.

Conditions related to something present in the cell may be based on a configuration index supported in the cell. For example, a WTRU may be provided with a configuration index (e.g., based on determination of the event or condition at event determination) associated with the configuration to be used in the target cell. The WTRU may determine the mobility type based on whether the target cell supports or not the configuration index. For example, the WTRU may determine whether the target cell supports the configuration index based on information broadcast by the target cell, for example, or based on information of the target cell received from the source cell.

Conditions related to something present in the cell may be based on whether the WTRU stays in a configured group of cells. For example, a WTRU may be provided with a list of cells and may determine the type of mobility based on whether it remains or not within the list of cells when performing the mobility.

Conditions related to something present in the cell may be based on the cell ID, or relationship between the cell IDs of the source cell and the target cell. For example, a subset of bits of the cell ID may be checked by the WTRU to determine a relationship between the source and target cells. If the WTRU moves from a source cell to a target cell which have the same value for the subset of the bits, the WTRU may assume a first mobility type, otherwise, it may assume a second mobility type.

One or more conditions may be related to the response from the network during the handover procedure. Such conditions may be based on the specific message received during the handover procedure. For example, a first mobility type may be associated with receiving a first message from the network during a handover procedure (e.g., following a RACH transmission) while a second mobility type may be associated with receiving a second message. Such conditions may be based on the contents of the message received during the handover procedure. For example, a first mobility type may be associated with receiving a first set of information (e.g., a configuration list) while a second mobility type may be associated with receiving a second (e.g., a configuration index).

One or more conditions may be explicit network configuration and/or indication. For example, a WTRU may receive a handover command indicating the type of handover or mobility type to apply

One or more conditions may be related to functional support by the cell. For example, a WTRU may determine, possibly at the time of the mobility procedure or prior to such, whether the cell supports a specific functionality, operation mode, etc., and/or whether a reconfiguration of the cell is required (as described herein). For example, a cell may broadcast an indication when it is supporting a specific functionality or operation mode. A WTRU may determine, based on an event or condition at the time of event described herein, that it requires a cell to support a specific functionality and may perform a first mobility type if the cell supports the functionality and/or a second mobility type otherwise. For example, a WTRU may determine, possibly at the time of the mobility procedure or prior to such, whether the cell is operating in a specific mode (e.g., network energy savings, cell DTX, limited transmit mode, etc.). A WTRU may determine the necessary network energy parameters associated with a specific event or condition which triggered the mobility herein, and may determine the mobility type based on whether the current parameters meet or are compatible with (e.g., based on network configuration or specification) the required parameters.

One or more conditions may be related to the event or conditions which trigger a mobility procedure, as described herein. For example, a WTRU may determine the mobility type based on the specific event, trigger or condition at trigger, as described earlier herein. For example, some events or conditions may be associated with a first mobility type, while a second event or condition may be associated with a second mobility type.

One or more conditions may be a period of time since the WTRU was provided with the configuration. For example, a WTRU may be provided with a configuration list and a set of indices each associated with a set of configuration parameters. A WTRU may assume it can apply such a configuration based on a determined or provided index for up to a maximum amount of time (e.g., configured) from the time it was provided the configuration list. The WTRU may then determine the mobility type based on whether the amount of time has expired or not.

A WTRU may be configured with, or store, multiple configuration lists (i.e., possibly set of configurations). Each list may be determine by a network element or network node (e.g., different DU). A WTRU, upon mobility to a cell may determine based on conditions herein (e.g., an area-related ID in the system information of the target cell) which list is applicable for determination of the configuration. For example, the WTRU may determine that for a cell associated with the first area identity, the WTRU may use a first reconfiguration list, while for a cell associated with a second area identity, the WTRU may use a second reconfiguration list. A WTRU may receive (e.g., in the handover command) or determine (e.g., based on events and/or conditions described herein) an index associated with the reconfiguration. The WTRU may determine the value of its configuration parameter (e.g., apply the configuration parameters given by) by selecting the list associated with the area identity of the target, and selecting the configuration associated with the received index from that list.

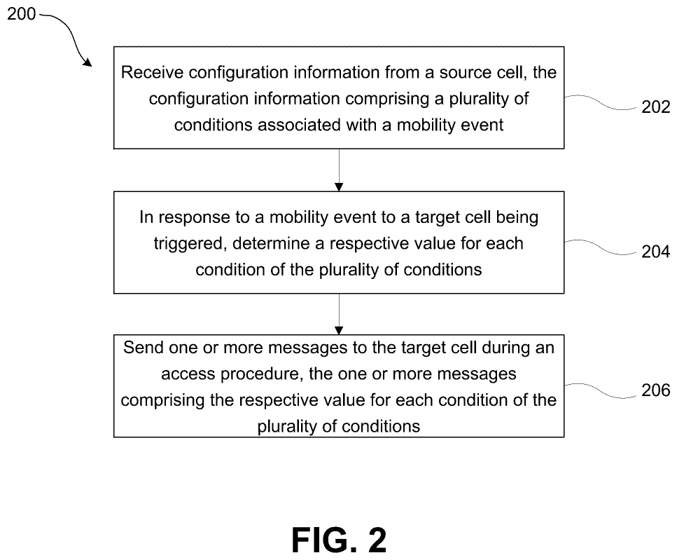

FIG. 2 is a flowchart diagram 200 illustrating a method in accordance with an embodiment. The method may be implemented by a wireless transmit/receive unit (WTRU). At 202, the WTRU receives configuration information (e.g., via RRC) from a source cell. The configuration information may comprise a plurality of conditions associated with a mobility event. At 204, in response to a mobility event to a target cell being triggered (e.g., based on a network triggered handover command, a conditional mobility triggered at the WTRU, etc.), the WTRU determines a respective value for each condition of the plurality of conditions. At 206, the WTRU sends one or more messages to the target cell during an access procedure (e.g., RACH procedure), wherein the one or more messages comprise the respective value for each condition of the plurality of conditions (e.g., in one or more information elements).

1. A wireless transmit/receive unit (WTRU) comprising:
a processor configured to:
receive configuration information from a source cell, wherein the configuration information comprises a plurality of conditions associated with a mobility event;
in response to a mobility event to a target cell being triggered, determine a respective value for each condition of the plurality of conditions; and
send one or more messages to the target cell during an access procedure, wherein the one or more messages comprise the respective value for each condition of the plurality of conditions.

2. The WTRU of claim 1, wherein the access procedure occurs before a radio resource control (RRC) exchange is performed between the WTRU and the target cell.

3. The WTRU of claim 1, wherein the plurality of conditions comprise one or more of: (i) one or more measurements associated with at least one of the source cell or a neighboring cell during the mobility event, (ii) one or more properties of data available for transmission at the WTRU, (iii) one or more properties of transmission resources available to the WTRU, (iv) one or more properties of the target cell, (v) power consumption at the WTRU, (vi) one or more quality of service (QoS) levels associated with the WTRU, (vii) capabilities of the WTRU, (viii) an identifier associated with the configuration information, or (ix) or a cell or group of cells which provided the configuration information.

4. The WTRU of claim 1, wherein the configuration information comprises:
a plurality of layer 1 (L1)/layer 2 (L2) configuration parameters, and
a plurality of configuration indices associated with the plurality of L1/L2 configuration parameters.

5. The WTRU of claim 4, wherein the processor is configured to:
determine a configuration index and configuration parameters for the WTRU to use with the target cell based on a type of mobility or reconfiguration procedure,
wherein the type of mobility or reconfiguration procedure is associated with one or more of: (i) a feature of a network architecture, (ii) an enabling of one or more of a new service, operation mode, capability, or category at the WTRU, (iii) an absence of information broadcast by the target cell, or (iv) an absence of support by the target cell of one or more of a feature, functionality, or configuration.

6. The WTRU of claim 5, wherein, if the type of mobility or reconfiguration procedure is a first type, the processor is configured to:
store a list of L1/L2 configurations in a conditional configuration as a new list of L1/L2 configurations, and
apply an L1/L2 configuration indicated by the configuration index.

7. The WTRU of claim 5, wherein, if the type of mobility or reconfiguration procedure is a second type, the processor is configured to:
apply an L1/L2 configuration indicated by the configuration index.

8. The WTRU of claim 5, wherein the processor is configured to determine the type of mobility or reconfiguration procedure based on at least one condition of the plurality of conditions.

9. The WTRU of claim 5, wherein the processor is configured to:
receive, from the target cell, an indication of the type of mobility or reconfiguration procedure.

10. The WTRU of claim 1, wherein the processor is configured to:
select the target cell based on a triggered event or data received by the WTRU.

11. A method implemented by a wireless transmit/receive unit (WTRU), the method comprising:
receiving configuration information from a source cell, wherein the configuration information comprises a plurality of conditions associated with a mobility event;
in response to a mobility event to a target cell being triggered, determining a respective value for each condition of the plurality of conditions; and
sending one or more messages to the target cell during an access procedure, wherein the one or more messages comprise the respective value for each condition of the plurality of conditions.

12. The method of claim 11, wherein the access procedure occurs before a radio resource control (RRC) exchange is performed between the WTRU and the target cell.

13. The method of claim 11, wherein the plurality of conditions comprise one or more of: (i) one or more measurements associated with at least one of the source cell or a neighboring cell during the mobility event, (ii) one or more properties of data available for transmission at the WTRU, (iii) one or more properties of transmission resources available to the WTRU, (iv) one or more properties of the target cell, (v) power consumption at the WTRU, (vi) one or more quality of service (QoS) levels associated with the WTRU, (vii) capabilities of the WTRU, (viii) an identifier associated with the configuration information, or (ix) or a cell or group of cells which provided the configuration information.

14. The method of claim 11, wherein the configuration information comprises
a plurality of layer 1 (L1)/layer 2 (L2) configuration parameters, and
a plurality of configuration indices associated with the plurality of L1/L2 configuration parameters.

15. The method of claim 14, further comprising:
determining a configuration index and configuration parameters for the WTRU to use with the target cell based on a type of mobility or reconfiguration procedure,
wherein the type of mobility or reconfiguration procedure is associated with one or more of: (i) a feature of a network architecture, (ii) an enabling of one or more of a new service, operation mode, capability, or category at the WTRU, (iii) an absence of information broadcast by the target cell, or (iv) an absence of support by the target cell of one or more of a feature, functionality, or configuration.

16. The method of claim 15, wherein, if the type of mobility or reconfiguration procedure is a first type, the method further comprises:
storing a list of L1/L2 configurations in a conditional configuration as a new list of L1/L2 configurations, and
applying an L1/L2 configuration indicated by the configuration index.

17. The method of claim 15, wherein, if the type of mobility or reconfiguration procedure is a second type, the method further comprises:
applying an L1/L2 configuration indicated by the configuration index.

18. The method of claim 15, further comprising determining the type of mobility or reconfiguration procedure based on at least one condition of the plurality of conditions.

19. The method of claim 15, further comprising receiving, from the target cell, an indication of the type of mobility or reconfiguration procedure.

20. The method of claim 11, further comprising selecting the target cell based on a triggered event or data received by the WTRU.
